(19) United States
(12) Patent Application Publication
(10) Pub. No.: US 2024/0386509 A1
(43) Pub. Date: Nov. 21, 2024

(54) METHOD AND APPARATUS FOR DISPLAYING MESSAGE BASED ON SOCIAL SCENE, DEVICE, MEDIUM, AND PRODUCT

(71) Applicant: Tencent Technology (Shenzhen) Company Limited, Shenzhen (CN)

(72) Inventor: Teng CHEN, Shenzhen (CN)

(73) Assignee: Tencent Technology (Shenzhen) Company Limited, Shenzhen (CN)

(21) Appl. No.: 18/785,322

(22) Filed: Jul. 26, 2024

Related U.S. Application Data
(63) Continuation of application No. PCT/CN2023/119168, filed on Sep. 15, 2023.

(30) Foreign Application Priority Data
Sep. 26, 2022 (CN) 202211176695.X

(51) Int. Cl. G06Q 50/00; A63F 13/79; H04L 67/306

(52) U.S. Cl. CPC G06Q 50/01; A63F 13/79; H04L 67/306

(57) ABSTRACT

A method for displaying a message based on a social scene, performed by a terminal device, includes: displaying a first scene picture corresponding to a virtual scene in a first observation range; displaying, based on receiving a first social message transmitted from a second social account, a first message prompt element and a first account identification element corresponding to the second social account; displaying, based on a second social object corresponding to the second social account being in the virtual scene, a positioning mark element at a determined position corresponding to the first account identification element; and switching, based on the positioning mark element, from the first observation range to a second observation range, to display a second scene picture corresponding to the virtual scene based on a first triggering operation being performed on the first account identification element.

### CROSS-REFERENCE TO RELATED APPLICATIONS

This application is a continuation application of International Application No. PCT/CN2023/119168 filed on Sep. 15, 2023, which claims priority to Chinese Patent Application No. 202211176695.X, filed with the China National Intellectual Property Administration on Sep. 26, 2022, the disclosures of each being incorporated by reference herein in their entireties.

### FIELD

The disclosure relates to the field of computer and Internet technologies, and in particular, to a method and an apparatus for displaying a message based on a social scene, a device, a medium, and a product.

### BACKGROUND

With the rapid development of computer technologies and the diversification of terminal devices, electronic games are gradually widely used. Social games are a popular type of game, in which a virtual scene is displayed on a terminal device, and a user controls a virtual social object in the virtual scene to perform a plurality of social activities with virtual social objects controlled by other users.

In the related art, when a social message transmitted from a social account is received, prompt information corresponding to the social message is displayed on a current virtual scene picture. A user switches a perspective of the scene picture based on the prompt information to find out a virtual social object corresponding to the social account, to realize virtual interactions and communication between virtual social objects.

However, in the related art, prompt information may only prompt a user that there is a social message transmitted from a social account. Therefore, a correlation between social activities and message content in a virtual scene is low, function indication of messages is relatively single, and indication efficiency of a message is relatively poor.

### SUMMARY

Provided are a method and an apparatus for displaying a message based on a social scene, a device, a medium, and a product, so that a message indication effect can be improved. The technical solutions are as follows:

According to some embodiments, a method for displaying a message based on a social scene, performed by a terminal device, includes: displaying a first scene picture corresponding to a virtual scene in a first observation range, the virtual scene including a plurality of virtual social objects that correspond to a plurality of social accounts, wherein the plurality of virtual social objects include a first social object corresponding to a first social account logged in with the terminal device; displaying, based on receiving a first social message transmitted from a second social account, a first message prompt element and a first account identification element corresponding to the second social account, the first message prompt element being configured for triggering display of message content of the first social message; displaying, based on a second social object corresponding to the second social account being in the virtual scene, a positioning mark element at a determined position corresponding to the first account identification element, wherein the positioning mark element indicates the second social object is in the virtual scene; and switching, based on the positioning mark element, from the first observation range to a second observation range, to display a second scene picture corresponding to the virtual scene based on a first triggering operation being performed on the first account identification element, wherein the virtual scene includes the second social object in the second observation range.

According to some embodiments, an apparatus for displaying a message based on a social scene, the apparatus including: at least one memory configured to store computer program code; and at least one processor configured to read the program code and operate as instructed by the program code, the program code including: scene picture code configured to cause at least one of the at least one processor to display a first scene picture corresponding to a virtual scene in a first observation range, the virtual scene including a plurality of virtual social objects that correspond to a plurality of social accounts, wherein the plurality of virtual social objects include a first social object corresponding to a first social account logged in with a terminal device; message prompt code configured to cause at least one of the at least one processor to display, based on receiving a first social message transmitted from a second social account, a first message prompt element and a first account identification element corresponding to the second social account, the first message prompt element being configured for triggering display of message content of the first social message; positioning mark code configured to cause at least one of the at least one processor to display, based on a second social object corresponding to the second social account being in the virtual scene, a positioning mark element at a determined position corresponding to the first account identification element, wherein the positioning mark element indicates the second social object is in the virtual scene; and switching code configured to cause at least one of the at least one processor to switch, based on the positioning mark element, from the first observation range to a second observation range, to display a scene picture corresponding to the virtual scene in response to receiving a first triggering operation performed on the first account identification element, wherein the virtual scene includes the second social object in the second observation range.

According to some embodiments, a non-transitory computer-readable storage medium, storing computer code which, when executed by at least one processor, causes the at least one processor to at least: display a first scene picture corresponding to a virtual scene in a first observation range, the virtual scene including a plurality of virtual social objects that correspond to a plurality of social accounts, wherein the plurality of virtual social objects include a first social object corresponding to a first social account logged in with a terminal device; display, based on receiving a first social message transmitted from a second social account, a first message prompt element and a first account identification element corresponding to the second social account, the first message prompt element being configured for triggering display of message content of the first social message; display, based on a second social object corresponding to the second social account being in the virtual scene, a positioning mark element at a determined position corresponding to the first account identification element, wherein the positioning mark element indicates the second social object is in the virtual scene; and switch, based on the positioning mark element, from the first observation range to a second observation range, to display a scene picture corresponding to the virtual scene in response to receiving a triggering operation performed on the first account identification element, wherein the virtual scene includes the second social object in the second observation range.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a method for displaying a message based on a social scene according to some embodiments.

FIG. 2 is a schematic diagram of an implementation environment according to some embodiments.

FIG. 3 is a structural block diagram of an electronic device according to some embodiments.

FIG. 4 is a flowchart of a method for displaying a message based on a social scene according to some embodiments.

FIG. 5 is a flowchart of a method for displaying a message based on a social scene according to some embodiments.

FIG. 6 is a schematic diagram of a message content interface according to some embodiments.

FIG. 7 is a schematic diagram of a positioning mark element according to some embodiments.

FIG. 8 is a flowchart of a method for displaying a message based on a social scene according to some embodiments.

FIG. 9 is a schematic diagram of a message triggering element according to some embodiments.

FIG. 10 is a schematic diagram of a message carrying bar according to some embodiments.

FIG. 11 is a schematic diagram of element display switching according to some embodiments.

FIG. 12 is a schematic diagram of hiding according to some embodiments.

FIG. 13 is a schematic diagram of observation range switching according to some embodiments.

FIG. 14 is a schematic diagram of an account content interface according to some embodiments.

FIG. 15 is a flowchart of a method for displaying a message based on a social scene according to some embodiments.

FIG. 16 is an interaction diagram of a method for displaying a message based on a social scene according to some embodiments.

FIG. 17 is a structural diagram of an apparatus for displaying a message based on a social scene according to some embodiments.

FIG. 18 is a structural diagram of an apparatus for displaying a message based on a social scene according to some embodiments.

FIG. 19 is a structural block diagram of a terminal device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

First, terms involved in some embodiments are briefly described.

Virtual scene: It is a virtual scene displayed (or provided) by an application when running in a terminal device, and is also referred to as a virtual scene. The virtual scene may be a simulated environment for the real world, or may be a semi-simulated and semi-fictitious three-dimensional environment, or may be a purely fictitious three-dimensional environment. The virtual scene may be any one of a two-dimensional virtual scene, a 2.5-dimensional virtual scene, and a three-dimensional virtual scene. In some embodiments, a description is provided by using an example in which the virtual scene is the two-dimensional virtual scene, but the disclosure is not limited thereto.

Virtual object: It is a movable object in a virtual scene. The movable object may be a virtual chess piece, a virtual person, a virtual animal, an anime figure, or the like, for example, a person, an animal, a plant, an oil barrel, a wall, or a stone displayed in a virtual scene. In some embodiments, the virtual object is a three-dimensional model created based on a skeletal animation technology. Each virtual object has a shape and a volume in a virtual scene, and occupies a partial space in the virtual scene.

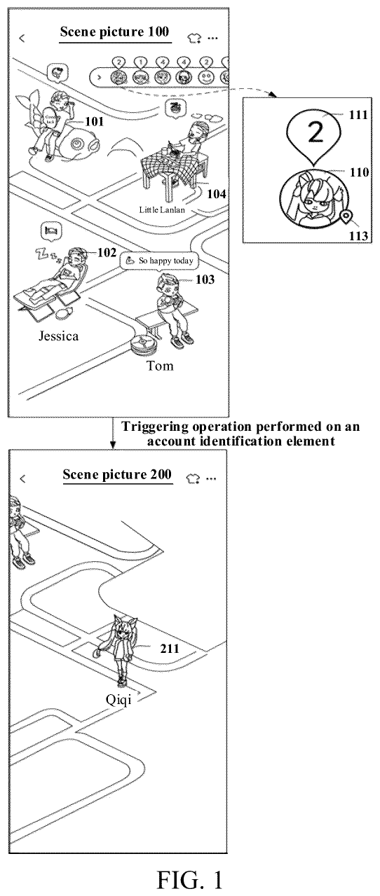

First, FIG. 1 is a schematic diagram of a method for displaying a message based on a social scene according to some embodiments. As shown in FIG. 1, a scene picture 100 corresponding to a virtual scene is displayed in a first observation range. The virtual scene includes virtual social objects respectively corresponding to a plurality of social accounts. For example, the current scene picture 100 includes a virtual social object 101, a virtual social object 102, a virtual social object 103, and a virtual social object 104. In addition, a virtual social object corresponding to a social account may be not in the virtual scene.

When a social message transmitted from a second social account is received, a message prompt element 110 and an account identification element 111 corresponding to the second social account are displayed in the virtual scene. The message prompt element 110 is configured for triggering display of message content of the social message. In addition, since a second social object 211 corresponding to the second social account is in the virtual scene, a positioning mark element 113 is displayed at a position corresponding to the account identification element 111. The positioning mark element indicates that the second social object 211 is in the virtual scene.

When a triggering operation performed on the account identification element 111 is received, switching from the first observation range to a second observation range is performed based on the positioning mark element 113, and a scene picture 200 corresponding to the virtual scene is displayed in the second observation range. The second social object 211 is in the scene picture 200.

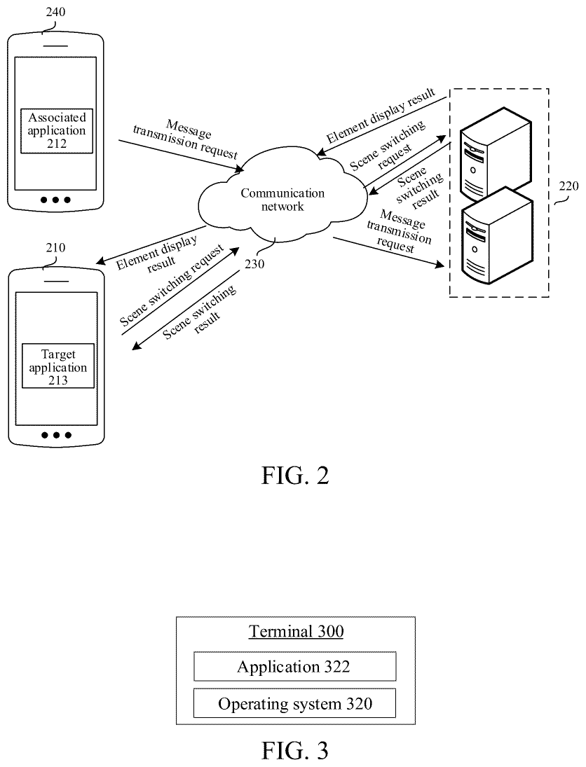

An implementation environment is described. FIG. 2 is a schematic diagram of an implementation environment according to some embodiments. The implementation environment includes a first terminal 210, a server 220, a second terminal 240, and a communication network 230. The first terminal 210, the second terminal 240, and the server 220 are connected through the communication network 230.

The first terminal 210 and the second terminal 240 each have a target application 213 installed and running therein. The first terminal 210 has the target application 213 running therein, and the second terminal 240 has an associated application 212 running therein. The target application 213 is an application supporting a two-dimensional virtual scene or a three-dimensional virtual scene, and the target application 213 is an application having a message communication function. The target application 213 may be any one of a virtual reality application, a three-dimensional map program, a social game, an auto chess game, a strategy game, a puzzle game, a third-person shooting game (TPS), a first-person shooting game (FPS), a multiplayer online battle arena game (MOBA), and a multiplayer shootout survival game.

The associated application 212 is an application having the message communication function, and the associated application 212 is an application having an association relationship with the target application 213.

As shown in FIG. 2, a description is provided by using an example in which the first terminal 210 has the target application 213 running therein and the second terminal 240 has the associated application 212 running therein (or the second terminal 240 may have both the target application 213 and the associated application 212 running therein, which is not limited). The target application 213 is currently implemented as a social application. The first terminal 210 displays a scene picture corresponding to a virtual scene in a first observation range, the virtual scene including a first social object corresponding to a first social account logged in with the first terminal 210.

The second terminal 240 has the associated application program 212 running therein. When receiving a message transmission operation, the second terminal 240 generates a message transmission request and transmits the message transmission request to the server 220. The message transmission request includes a social message transmitted from a second social account and position information of a second social object.

When receiving the message transmission request transmitted by the second terminal 240, the server 220 determines that the second social object is currently in the virtual scene based on the position information, generates an element display result based on the message transmission request, and transmits the element display result to the first terminal 210. The element display result includes a message prompt element and an account identification element corresponding to the second social account, and a positioning mark element indicating that the second social object is in the virtual scene.

When receiving the element display result, the first terminal 210 displays the account identification element and the message prompt element corresponding to the second social account in the scene picture corresponding to the first observation range based on the element display result. The message prompt element is configured for providing a message entry. By triggering the message prompt element, the first terminal 210 displays social content corresponding to the social message on the scene picture corresponding to the first observation range in an overlaying manner. In addition, the positioning mark element is displayed at a position corresponding to the account identification element.

When receiving a triggering operation performed on the account identification element, the first terminal 210 generates a scene switching request, and transmits the scene switching request to the server 220. The scene switching request is configured for requesting for switching from the first observation range to a second observation range in which the second social object is located. After receiving the scene switching request, the server 220 determines the second observation range in which the second social object is located based on position information of the second social object in the virtual scene, and generates a scene switching result and feeds back the scene switching result to the first terminal 210. When receiving the scene switching result, the first terminal 210 displays a scene switching animation showing switching from the first observation range to the second observation range, and displays a scene picture corresponding to the second observation range. The scene picture corresponding to the second observation range includes the second social object.

The above terminal device may be terminal devices of a plurality of forms, such as a desktop computer, a laptop computer, a mobile phone, a tablet computer, an e-book reader, a moving picture experts group audio layer III (MP3) player, a moving picture experts group audio layer IV (MP4) player, a smart television, and a smart on-board device, which is not limited in some embodiments.

The server 220 includes at least one of one server, a plurality of servers, a cloud computing platform, and a virtualization center. In some embodiments, the server 220 is in charge of primary computing works, and the first terminal 210 is in charge of secondary computing works. The server 220 is in charge of the secondary computing works, and the first terminal 210 is in charge of the primary computing works. The server 220 and the first terminal 210 perform collaborative computing through a distributed computing architecture.

The server may be an independent physical server, or may be a server cluster formed by a plurality of physical servers or a distributed system, or may be a cloud server providing cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence platform.

The cloud technology is a hosting technology that unifies a series of resources such as hardware, software, and a network in a wide area network or a local area network to implement calculation, storage, processing, and sharing of data.

In some embodiments, the server may be implemented as a node in a blockchain system.

A prompt interface and a pop-up window may be displayed or voice prompt information may be outputted before and during collection of relevant data of a user. The prompt interface, the pop-up window, or the voice prompt information is configured for prompting the user that relevant data of the user is currently being collected. Operations of obtaining user-related data may be performed after a confirmation operation performed by the user on the prompt interface or the pop-up window is obtained. Otherwise (for example, when no confirmation operation performed by the user on the prompt interface or the pop-up window is obtained), the relevant operations of obtaining user-related data are ended, for example, the user-related data is not obtained. User data (including account information of a social account) collected should be processed in accordance with requirements of relevant national laws and regulations, informed consent or individual consent of a subject of the personal information is collected with consent and authorization of the user, subsequent use and processing behaviors of data are performed within the scope of authorization of laws and regulations and the subject of the personal information, and the collection, use, and processing of the user-related data should comply with relevant laws, regulations, and standards of relevant countries and regions.

FIG. 3 is a structural block diagram of an electronic device according to some embodiments. An electronic device 300 includes an operating system 320 and an application 322.

The operating system 320 is software providing secure access to computer hardware for the application 322.

The application 322 is an application supporting a virtual scene. In some embodiments, the application 322 is an application supporting a three-dimensional virtual scene. The application 322 may be any one of a virtual reality application, a three-dimensional map program, a social application, a TPS, an FPS, an MOBA, a multiplayer shootout survival game, a social game, a puzzle game, and a strategy game. The application 322 may be a stand-alone application, for example, a stand-alone game program, or may be an online application.

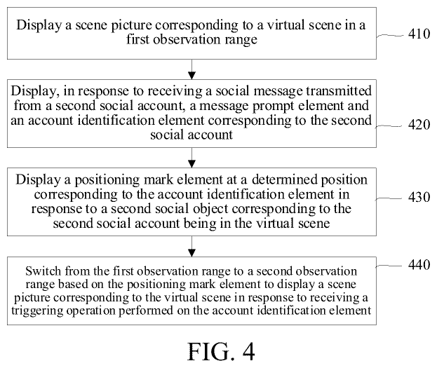

Based on the above introduction, a method for displaying a message based on a social scene is described. The method may be performed by a terminal device, or may be performed jointly by a server and a terminal device. In some embodiments, a description is provided by using an example in which the method is performed by a terminal device. As shown in FIG. 4, the method includes the following operations.

Operation 410: Display a scene picture corresponding to a virtual scene in a first observation range.

The virtual scene includes virtual social objects respectively corresponding to a plurality of social accounts, and the virtual social objects include a first social object corresponding to a first social account logged in with the terminal device.

The scene picture corresponding to the virtual scene is a running interface of a target application running in the terminal device.

In some embodiments, the social account refers to an account logged in with a client of the target application.

The first observation range refers to a viewing range of the virtual scene when observed from a perspective of the first social object corresponding to the first social account logged in with the terminal device.

In some embodiments, the perspective of the first social object may be implemented as a first person perspective, or the perspective of the first social object may be implemented as a third person perspective, which is not limited.

The virtual social object refers to a virtual object that is controlled by using a social account and can perform social activities in a virtual scene. The social activities include at least one of dialog communication, voice transmission, video sharing, picture sharing, completing a task (for example, a social object 1 and a social object 2 both perform a “hand heart” showing action, or a social object a completes a dance), and posting dynamic content.

In some embodiments, the social activities include social activities independently performed by a virtual social object under control of a social account or social activities jointly performed by virtual social objects respectively corresponding to a plurality of social accounts, which is not limited.

In some embodiments, the first social account corresponds to at least one first social object in the virtual scene.

In some embodiments, some of the virtual social objects respectively corresponding to the plurality of social accounts included in the virtual scene are displayed in the scene picture corresponding to the first observation range, and some of the virtual social objects are not displayed in the virtual scene picture corresponding to the first observation range.

In some embodiments, the virtual social objects respectively corresponding to the plurality of social accounts are located at fixed positions in the virtual scene, or the virtual social objects respectively corresponding to the plurality of social accounts may move in the virtual scene.

In some embodiments, a position of a virtual social object in the virtual scene is controlled by a corresponding social account, or the position of the virtual social object in the virtual scene is controlled by a first social account currently logged in with the terminal device, which is not limited.

Operation 420: Display, in response to receiving a social message transmitted from a second social account, a message prompt element and an account identification element corresponding to the second social account.

The message prompt element is configured for triggering display of message content of the social message.

The social message refers to a message transmitted from the second social account and configured for an account interaction with the first social account. The account interaction may include control of the virtual social object to perform a social activity involved in operation 410, or the interaction between the first social account and the second social account. Interaction content includes at least one of activities such as chatting, voice transmission, video sharing, picture sharing, and posting dynamic content.

The above control of the virtual social object to perform the social activity and the interaction between the social accounts are two different types of activities.

In some embodiments, the social message is a message transmitted from the second social account through another social platform, for example, an associated application having an association relationship with the target application, or a subprogram of the target application. The social message is a message transmitted from the second social account through the target application.

In some embodiments, the message prompt element is configured for providing a message entry, to connect the scene picture corresponding to the virtual scene to a message interface corresponding to the social message, and the message prompt element is triggered to display the message content corresponding to the social message.

In some embodiments, a display manner of the message content includes at least one of the following manners:
1. After the message prompt element is triggered, a jump is from the scene picture corresponding to the virtual scene to the message content interface corresponding to the social message is achieved. The message prompt element may be triggered to achieve a jump between different interfaces.
2. After the message prompt element is triggered, the message content interface corresponding to the social message is displayed on the scene picture corresponding to the virtual scene in an overlaying manner. The message prompt element may be trigged to achieve display of different interfaces in an overlaying manner.

The above display manners of the message content are exemplary, and the display manner of the message content is not limited.

In some embodiments, the message prompt element includes at least one of element content such as a social message quantity, a social message type (a text/an image/a voice), and message transmission time.

When a social message transmitted from the second social account is received for the first time, the message prompt element and the account identification element corresponding to the second social account are displayed in the scene picture. When a social message transmitted from the second social account is received subsequently, the element content of the message prompt element is changed correspondingly, to indicate that a new social message transmitted from the second social account currently exists.

During the above receiving of the social message transmitted from the second social account, each time a social message is transmitted from the second social account, the element content of the message prompt element is immediately updated and displayed, or a social message transmitted from the second social account is received at a time interval, to update and display the element content of the message prompt element.

In some embodiments, the account identification element is configured for representing identity information corresponding to a social account of a currently received and unread social message. When social messages transmitted from different social accounts are received, account identification elements respectively corresponding to a plurality of social accounts are respectively displayed.

In some embodiments, when a social message is read after a triggering operation is performed on a message prompt element, display of an account identification element and a message prompt element (and a positioning mark element (if existing)) corresponding to a social account from which the social message is transmitted is canceled. When the social message is read after the triggering operation is performed on the message prompt element, display of the account identification element corresponding to the social account from which the social message is transmitted is maintained, and display of the message prompt element is canceled (display of the positioning mark element (if existing) is maintained).

Operation 430: Display a positioning mark element at a position corresponding to the account identification element in response to a second social object corresponding to the second social account being in the virtual scene.

The positioning mark element indicates that the second social object is in the virtual scene.

The positioning mark element indicates that the second social object is currently a virtual social object in the virtual scene. The second social object is in the scene picture corresponding to the first observation range, or the second social object is outside the scene picture corresponding to the first observation range, which is not limited.

In some embodiments, the positioning mark element is displayed at the position corresponding to the account identification element after the message prompt element and the account identification element corresponding to the second social account are displayed. When the social message transmitted from the second social account is received, the message prompt element, the account identification element, and the positioning mark element corresponding to the second social account are displayed simultaneously.

Operation 420 and operation 430 may be performed in sequence, or operation 420 and operation 430 may be performed simultaneously, which is not limited.

In some embodiments, a display manner of the positioning mark element includes at least one of the following manners:
1. The positioning mark element is displayed at a fixed position of the account identification element. In a current case, the positioning mark element is displayed at a fixed position.
2. The positioning mark element is displayed at a position at which the account identification element remains in a direction the same as that of the relative position based on a relative position of the second social object in the scene picture corresponding to the current first observation range. For example, if the second social object is at a position in an east direction of the scene picture corresponding to the first observation range, the positioning mark element is displayed at a position on a right side of the account identification element. For another example, if the second social object is at a position in a north direction of the scene picture corresponding to the first observation range, the positioning mark element is displayed at a position above the account identification element.
3. The positioning mark element is displayed at the position of the account identification element based on a relative position of the second social object in the scene picture corresponding to the current first observation range, the positioning mark element has element display content therein, and element display content indicates the above relative position. For example, if the second social object is at a position in the east direction of the scene picture corresponding to the first observation range, the positioning mark element is displayed at a fixed position of the account identification element, a direction indication element is displayed in the positioning mark element, and the direction indication element points to a right direction of the scene picture corresponding to the current first observation range, and indicates that the second social object is at a position in the direction.
4. A distance between a position of the second social object in the virtual scene and the scene picture corresponding to the current first observation range is obtained, and the positioning mark element is displayed in an element display size at the position of the account identification element based on the distance. For example, when the distance reaches a first distance threshold, the positioning mark element is displayed in a first display size. When the distance reaches a second distance threshold (the second distance threshold is greater than the first distance threshold), the positioning mark element is displayed in a second display size (the second display size is less than the first display size). A larger distance may indicate a smaller element display size.

The above display manners of the positioning mark element are exemplary, and the display manner of the positioning mark element is not limited.

In the above third case, the element display content includes at least one of different types of element content such as a direction indication element (for example, an arrow mark), a text element (for example, text elements such as “east”, “south”, “west”, and “north” are displayed), and a color element (for example, an east side is displayed as red, and a north side is displayed as yellow), which is not limited.

In some embodiments, the display of the positioning mark element is continuous without changes. The display manner of the positioning mark element may be determined based on a position of the second social object at the moment when a social message is received, and the positioning mark element may be continuously displayed. The display of the positioning mark element is changed with the position of the second social object in the virtual scene. For example, when the second social object is located in the east direction of the first observation range when a social message is received, the positioning mark element is displayed on the right side of the account identification element. If the second social object moves to a west direction of the first observation range before the account identification element is triggered, an element movement animation presenting movement of the positioning mark element from the right side of the account identification element to a left side is displayed, which is not limited.

Operation 440: Switch from the first observation range to a second observation range based on the positioning mark element to display a scene picture corresponding to the virtual scene in response to receiving a triggering operation performed on the account identification element.

A virtual scene in the second observation range includes the second social object.

In some embodiments, the second observation range refers to a viewing range of the virtual scene when observed from a perspective of the second social object corresponding to the first social account logged in with the terminal device.

In some embodiments, the second observation range is an observation range centered around the second social object.

In some embodiments, when social messages respectively transmitted from a plurality of social accounts are received, the second observation range is an observation range including virtual social objects respectively corresponding to the plurality of social accounts.

In some embodiments, the second observation range and the first observation range are observation ranges completely different from each other, or the second observation range and the first observation range partially overlap, which is not limited.

In some embodiments, a focal length of a viewing angle corresponding to the second observation range is the same as a focal length of a viewing angle corresponding to the first observation range. A process of the switching from the first observation range to the second observation range may involve rotating the viewing angle from a direction to another direction. The focal length of the viewing angle corresponding to the second observation range is different from the focal length of the viewing angle corresponding to the first observation range. The process of the switching from the first observation range to the second observation range may involve rotating the viewing angle from a direction to another direction, and changing the focal length (for example, lengthening or shortening the focal length) of the viewing angle, which is not limited.

In some embodiments, the scene picture corresponding to the virtual scene displayed in the second observation range may include the second social object, or the second social object and other virtual social objects (including virtual social objects within or outside the first observation range), which is not limited.

In some embodiments, the switching of the observation range based on the positioning mark element is achieved in at least one of the following manners:
1. An animation presenting range switching from the first observation range may be achieved when the account identification element in which the positioning mark element is displayed is triggered. The positioning mark element may indicate feasibility of the observation range switching.
2. When the account identification element is triggered, a movement animation exists for the positioning mark element during the switching from the first observation range to the second observation range. The observation range switching process involves movement with the movement of the positioning mark element, and an observation range switching direction is the same as a movement direction of the positioning mark element. In a current case, the positioning mark element has a function of guiding the observation range switching.

In some embodiments, in response to receiving a triggering operation performed on the positioning mark element, the switching from the first observation range to the second observation range based on the positioning mark element is performed, and the scene picture corresponding to the virtual scene is displayed.

In some embodiments, in response to receiving the triggering operation performed on the account identification element and/or the positioning mark element, the switching from the first observation range to the second observation range is performed based on the positioning mark element, to display the scene picture corresponding to the virtual scene.

The above manners of achieving the observation range switching based on the positioning mark element and the manners of triggering the observation range switching are exemplary, and the manner of achieving the observation range switching based on the positioning mark element and the manner of triggering the observation range switching are not limited.

In summary, according to the method for displaying a message based on a social scene provided in some embodiments, during the display of the scene picture corresponding to the virtual scene in the first observation range, when the social message transmitted from the second social account is received, the message prompt element and the account identification element corresponding to the second social account are displayed; since the second social object corresponding to the second social account is in the virtual scene, the positioning mark element is displayed at the position of the account identification element; and when the triggering operation performed on the account identification element is received, and the switching from the first observation range to the second observation range including the second social object is performed based on the positioning mark element, to display the scene picture. When the social message transmitted from the social account of the virtual social object in the virtual scene is received, the positioning mark element is displayed to notify a user that the virtual social object is currently in the virtual scene, so as to implement automatic switching from a current observation range to an observation range corresponding to the virtual social object based on the positioning mark element. Indication functions of a message may be diversified, thereby improving display efficiency of the message. In addition, the automatic switching function avoids a manual operation of the user. Therefore, except the current observation range and the observation range corresponding to the virtual social object, other observation ranges that are to be displayed during the manual operation of the user may not be displayed, reducing data overheads of computers.

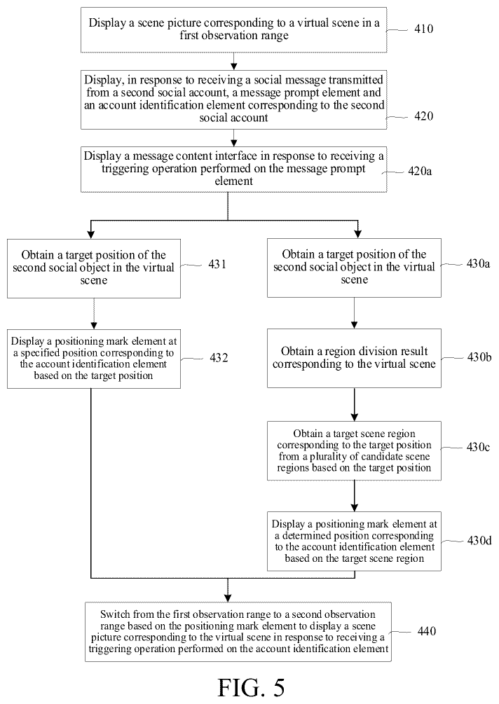

In some embodiments, a detailed description is provided for different display manners of the positioning mark element. FIG. 5 is a schematic diagram of a method for displaying a message based on a social scene according to some embodiments. Operation 430 further includes operation 431 and operation 432, or operation 430 further includes operation 430a, operation 430b, operation 430c, and operation 430d, and operation 420a is further included after operation 420. As shown in FIG. 5, the method includes the following operations.

Operation 420a: Display a message content interface in response to receiving a triggering operation performed on the message prompt element.

The message content interface includes the message content corresponding to the social message.

An interface function of the message content interface includes at least one of the following three different functions:
1. The message content interface is configured for displaying the message content corresponding to the social message.
2. The message content interface may display the message content corresponding to the social message and may provide an account communication function. The first social account may interact with the second social account through the message content interface.
3. The message content interface may display the message content corresponding to the social message and may also provide an interaction link. The first social account may view the message content corresponding to the social message in the message content interface and may jump to an account interaction interface by triggering the message content interface, to interact with the second social account on the account interaction interface.

In some embodiments, a triggering operation may be performed on a message prompt element corresponding to one associated account each time, and a message content interface corresponding to the associated account may be displayed. The triggering operation is performed on message prompt elements corresponding to a plurality of associated accounts successively, to obtain a plurality of message display interfaces simultaneously.

The associated account refers to an account having an association relationship with the first social account. A virtual social object corresponding to the associated account is located in the virtual scene (the associated account may be equivalent to a social account), or the virtual social object corresponding to the associated account is outside the virtual scene.

In some embodiments, that the virtual social object corresponding to the associated account is outside the virtual scene may have the following two cases:
1. The virtual social object corresponding to the associated account is in an unlogged state (for example, an invisible state or a non-viewable state). If the virtual social object corresponding to the associated account is in a logged state, the virtual social object corresponding to the associated account can be viewed in the virtual scene.
2. The virtual social object corresponding to the associated account is located in another virtual scene. The another virtual scene may be a virtual scene provided by the target application different from the above virtual scene, or may be a virtual scene provided by an application other than the target application.

An “associated account” is a concept of a “social account”.

In some embodiments, the message content interface includes a social message transmitted from a single associated account, or the message content interface includes social messages transmitted from a plurality of associated accounts, which is not limited.

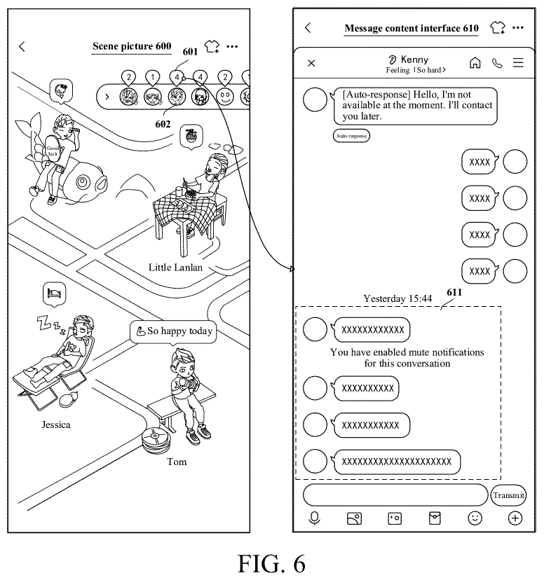

FIG. 6 is a schematic diagram of a message content interface according to some embodiments. As shown in FIG. 6, a scene picture 600 corresponding to the virtual scene is currently displayed in the first observation range. When a social message transmitted from a social account a is received, a message prompt element 601 and an account prompt element 602 corresponding to the social account a are displayed in the scene picture 600. When a triggering operation performed on the message prompt element 601 is received, a message content interface 610 is displayed on the scene picture 600 in an overlaying manner. The message content interface 610 includes message content 611 corresponding to the social message transmitted from the social account a.

In some embodiments, in response to successively receiving triggering operations performed on a plurality of message prompt elements, a triggering order corresponding to the plurality of message prompt elements is determined, and a message content interface corresponding to the first triggering operation in the triggering order is displayed, an (n+1)^{th} message content interface being hidden immediately after an n^{th} message content interface, n≥1, and n being an integer, and the (n+1)^{th} message content interface is displayed in response to receiving a sliding operation performed on the n^{th} message content interface.

In this embodiment, when message prompt elements corresponding to a plurality of associated accounts are displayed in the scene picture, if a triggering operation is performed on the message prompt elements corresponding to the plurality of associated accounts successively, a triggering order corresponding to the plurality of message prompt elements is determined based on an order of the triggering operations. First, a message content interface corresponding to a message prompt element corresponding to the first triggering operation in the triggering order is displayed on the scene picture in an overlaying manner, and a message content interface corresponding to a message prompt element corresponding to the second triggering operation in the triggering order is hidden immediately after the first message content interface. When a sliding operation performed on the first message content interface is received, the second message content interface is displayed. A message content interface corresponding to a message prompt element corresponding to the third triggering operation in the triggering order is hidden after the second message content interface. After successive triggering operations are received, the first message content interface may be displayed, and a plurality of message content interfaces may be subsequently viewed through sliding operations on the message content interface.

### A Plurality of Different Manners of Displaying the Positioning Mark Element are Described in Detail Below.

### In a First Manner, the Positioning Mark Element is Displayed Continuously at the Fixed Position of the Account Identification Element.

If the second social object corresponding to the second social account is in the virtual scene, the positioning mark element is displayed continuously at a fixed position in the message prompt element.

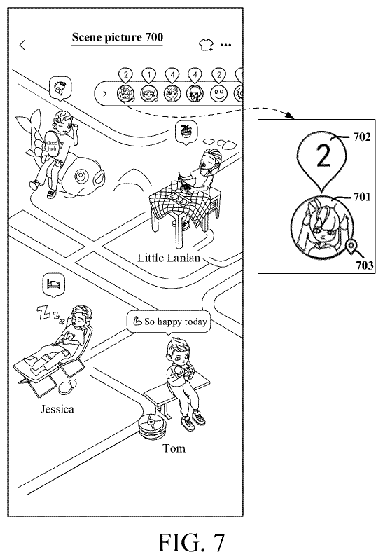

FIG. 7 is a schematic diagram of a positioning mark element according to some embodiments. As shown in FIG. 7, a scene picture 700 corresponding to the virtual scene is currently displayed in the first observation range. When a social message transmitted from the second social account is received, an account identification element 701 and a message prompt element 702 corresponding to the second social account are displayed in the scene picture 700. In addition, since the second social object corresponding to the second social account is in the virtual scene, a positioning mark element 703 is displayed at a lower right corner of the account identification element 701.

### In a Second Manner, the Positioning Mark Element Includes the Direction Indication Element.

Operation 431: Obtain a target position of the second social object in the virtual scene.

When the triggering operation performed on the message prompt element is received, position information, including at least one of position coordinates, a position direction, a position distance, and the like, of the second social object is obtained in the virtual scene.

The position coordinates refer to coordinate points of the second social object in a world coordinate system included in the virtual scene. The position direction refers to a relative position of the second social object in the scene picture corresponding to the current first observation range. The position distance refers to a distance between the position of the second social object and a center position in the scene picture corresponding to the current first observation range.

In some embodiments, a determination manner of the target position includes at least one of the following manners:
1. The virtual social object is at a fixed location in the virtual scene, and a server (or a local terminal device) has a file including position data corresponding to each virtual social object in the virtual scene stored therein. After the triggering operation performed on the message prompt element is received, position data corresponding to the second social object is obtained from the file, thereby obtaining the target position of the second social object.
2. The virtual social object may be controlled to move in the virtual scene through the social account. During the movement of the virtual social object, position data is generated in real time and transmitted to the server. After the triggering operation performed on the message prompt element is received, latest position data that is generated is obtained from the server, thereby obtaining the target position of the second social object.
3. The virtual social object may be controlled to move in the virtual scene through the social account. After the triggering operation performed on the message prompt element is received, position data of the second social object in the virtual scene at a current moment is obtained, thereby obtaining the target position of the second social object.

The above determination manners of the target position are exemplary, and the determination manner of the target position is not limited in some embodiments.

Operation 432: Display the positioning mark element at the position corresponding to the account identification element based on the target position.

The positioning mark element includes the direction indication element. The direction indication element indicates an orientation relationship between the target position and the scene picture corresponding to virtual scene displayed in the first observation range.

The direction indication element indicates a current direction of the second social object in the scene picture.

In some embodiments, during the display of the direction indication element, if the position of the second social object in the virtual scene varies, the direction indication element no longer varies. During the display of the direction indication element, if the position of the second social object in the virtual scene varies, the direction indication element varies with a real-time position of the second social object.

In this embodiment, a description is provided by using an example in which the positioning mark element is implemented as an arrow element. After the target position of the second social object in the virtual scene is obtained, a relative direction of the target position in the scene picture corresponding to the current first observation range is determined, and an indication direction of the arrow element is determined. During the display of the positioning mark element at the position of the account identification element, the positioning mark element includes the arrow element, and the arrow element points to a direction corresponding to the target position.

### In a Third Manner, a Region Indication Element is Displayed in the Positioning Mark Element.

Operation 430a: Obtain a target position of the second social object in the virtual scene.

For implementation details of content about the target position in operation 430a, reference may be made to the descriptions of operation 431.

Operation 430b: Obtain a region division result corresponding to the virtual scene.

The region division result includes a plurality of candidate scene regions corresponding to the virtual scene.

In some embodiments, the region division result includes a plurality of candidate scene regions pre-divided based on a division rule. The region division result includes a plurality of candidate scene regions divided by a user.

In some embodiments, the plurality of candidate scene regions are different regions.

In an example, the virtual scene is divided into a plurality of candidate scene regions based on a region quantity. The candidate scene regions correspond to a same area. For example, if the virtual scene is divided into eight regions with a same size, eight candidate scene regions with the same area are obtained as the region division result.

In an example, the virtual scene is divided based on a region type. Each candidate scene region corresponds to a different region type. For example, the virtual scene is divided into a “living region”, a “leisure region”, an “entertainment region”, and a “residential region”.

In an example, the virtual scene is divided based on a region display element. Each candidate scene region includes a different region display element. For example, the virtual scene is divided into a “grassland” (a grass element), a “sea of flowers” (a flower element), and a “desert” (a sand element).

Operation 430c: Obtain a target scene region corresponding to the target position from the plurality of candidate scene regions based on the target position.

When the target position of the second social object in the virtual scene is obtained, and the region division result corresponding to the virtual scene is obtained, a candidate scene region matching the target position is selected from the region division result as the target scene region based on the target position.

Operation 430d: Display the positioning mark element at the position corresponding to the account identification element based on the target scene region.

The positioning mark element includes a region indication element corresponding to the target scene region.

After the region division result corresponding to the virtual scene is obtained, each candidate scene region is correspondingly labeled with a different region indication element, and the positioning mark element is displayed at the position of the account prompt element corresponding to the second social account. The positioning mark element includes the region indication element corresponding to the target scene region.

### In a Fourth Manner, the Positioning Mark Element is Displayed in a Varying Element Display Size.

In some embodiments, an element display size of the positioning mark element is related to a distance between the second social object and the scene picture corresponding to the virtual scene displayed in the first observation range.

The target position of the second social object in the virtual scene is obtained to obtain a distance between the target position and the scene picture corresponding to the virtual scene displayed in the first observation range. In addition, a plurality of distance thresholds are preset, and each distance threshold corresponds to a different element display size. When the distance reaches a distance threshold, the positioning mark element is displayed at the element display size corresponding to the distance threshold.

In this embodiment, a larger distance indicates a smaller element display size.

In summary, according to the method for displaying a message based on a social scene provided in some embodiments, during the display of the scene picture corresponding to the virtual scene in the first observation range, when the social message transmitted from the second social account is received, the message prompt element and the account identification element corresponding to the second social account are displayed; since the second social object corresponding to the second social account is in the virtual scene, the positioning mark element is displayed at the position of the account identification element; and when the triggering operation performed on the account identification element is received, and the switching from the first observation range to the second observation range including the second social object is performed based on the positioning mark element, to display the scene picture. When the social message transmitted from the social account of the virtual social object in the virtual scene is received, the positioning mark element is displayed to notify a user that the virtual social object is currently in the virtual scene, so as to implement automatic switching from a current observation range to an observation range corresponding to the virtual social object based on the positioning mark element. Indication functions of a message may be diversified, thereby improving display efficiency of the message. In addition, the automatic switching function avoids a manual operation of the user, reducing data overheads of computers.

In this embodiment, the display of the direction indication element in the positioning mark element may indicate the virtual social object is located in the virtual scene, and may indicate a direction of the virtual social object, so that element display efficiency and diversity can be increased.

In this embodiment, the display of the region indication element in the positioning mark element may indicate that the virtual social object is located in the virtual scene and may indicate a region range of the virtual social object, so that the element display efficiency and diversity can be increased.

In this embodiment, the element display size of the positioning mark element is determined based on the distance between the position of the second social object and the scene picture corresponding to the first observation range. A user may be able to determine whether the second social object is far or close through the different element display sizes, thereby increasing the element display efficiency and diversity.

In this embodiment, the message content interface is displayed through the triggering operation performed on the message prompt element. A function of single click/tap for message content display may be achieved, thereby improving functionality of message display.

In this embodiment, the plurality of message content interfaces hidden immediately are received, so that after a plurality of triggering operations are performed, single click/tap for switching between the plurality message content interfaces may be achieved through an interface sliding operation, thereby improving human-computer interaction efficiency.

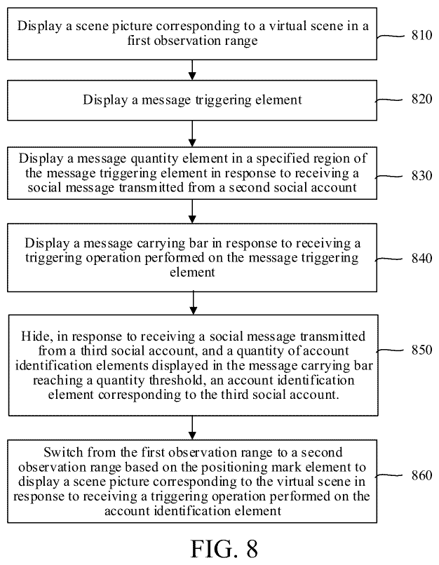

In some embodiments, exemplarily, FIG. 8 is a flowchart of a method for displaying a message based on a social scene according to some embodiments. As shown in FIG. 8, the method includes the following operations.

Operation 810: Display a scene picture corresponding to a virtual scene in a first observation range.

The virtual scene includes virtual social objects respectively corresponding to a plurality of social accounts, and the virtual social objects include a first social object corresponding to a first social account logged in with the terminal device.

The virtual scene includes virtual social objects respectively corresponding to a plurality of social accounts, and the virtual social objects include a first social object corresponding to a first social account logged in with the terminal device.

The first observation range refers to a viewing range of the virtual scene when observed from a third-person perspective corresponding to the first social object corresponding to the first social account logged in with the terminal device.

In some embodiments, the first social object is in the scene picture corresponding to the virtual scene displayed in the first observation range, or the first social object is outside the scene picture corresponding to the virtual scene displayed in the first observation range, which is not limited.

In some embodiments, in the virtual scene, at least one virtual social object may be controlled through each social account.

In some embodiments, each virtual social object in the virtual scene is a virtual social object with a same virtual image, or each virtual social object in the virtual scene is a virtual social object with a different virtual image, which is not limited.

In some embodiments, virtual social objects corresponding to a social account are all in the virtual scene, or a virtual social object corresponding to the social account is outside the virtual scene, which is not limited.

Operation 820: Display a message triggering element.

The message triggering element indicates that a social message transmitted from a social account may be received in a current virtual scene.

In some embodiments, the message triggering element is a fixed display element continuously displayed in the virtual scene. Regardless of whether a social message transmitted from a social account is received, the message triggering element is displayed in the scene picture corresponding to the virtual scene, or the message triggering element is displayed in the scene picture corresponding to the virtual scene after the social message transmitted from the social account is received for the first time, which is not limited.

For the above case in which the message triggering element is displayed after the social message is received, in some embodiments, after the message triggering element is displayed for the first time, the message triggering element is displayed continuously regardless of whether a social message is received. In some embodiments, after the message triggering element is displayed for the first time, if no social message is received within a time range, the display of the message triggering element is canceled, and the message triggering element is not displayed until a social message is received.

In some embodiments, a social message transmitted from a single social account corresponds to an independent message triggering element, or social messages transmitted from a plurality of social accounts correspond to a same message triggering element, which is not limited.

In this embodiment, the message triggering element is displayed at a fixed position in the scene picture corresponding to the virtual scene.

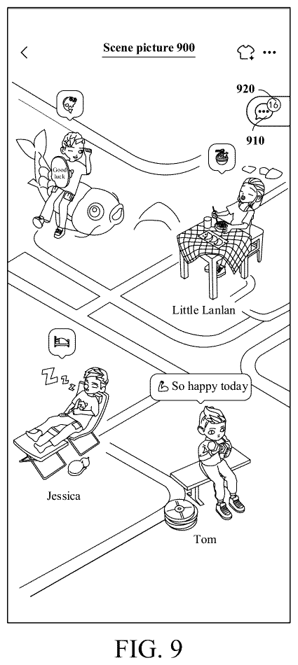

FIG. 9 is a schematic diagram of a message triggering element according to some embodiments. As shown in FIG. 9, a scene picture 900 corresponding to the virtual scene is currently displayed in the first observation range, and a message triggering element 910 is constantly displayed in the scene picture 900.

Operation 830: Display a message quantity element in a region of the message triggering element in response to receiving a social message transmitted from a second social account.

The message quantity element indicates a message quantity sum of currently received social messages transmitted from an associated account, and the associated account is an account having an association relationship with the first social account.

In some embodiments, the associated account refers to an account having a direct association relationship with the first social account. The direct association relationship means that the associated account can directly interact with the first social account.

The associated account is an account that can perform account interaction with the first social account. A virtual social object corresponding to the associated account may be in the virtual scene (the associated account is a social account), or the virtual social object corresponding to the associated account may be outside the virtual scene, which is not limited.

In some embodiments, the associated account refers to an account having an indirect association relationship with the first social account. The indirect association relationship means that the associated account has a direct association relationship with an associated account of the first social account. The associated account of the first social account refers to an account having the same feature as the first social account. For example, the associated account and the first social account have a same owner. For another example, the associated account and the first social account are logged in with a same terminal device. For another example, the associated account has a binding relationship with the first social account. The associated account is an account that can interact with the associated account of the first social account. The associated account may not have a corresponding virtual social object.

If the associated account refers to the account having the indirect association relationship with the first social account, to view a social message transmitted from the associated account, a user may jump to a message content interface provided by an application with which the associated account of the first social account is logged in.

In some embodiments, when the social message transmitted from the second social account is a social message that is currently received for the first time and not read, the message quantity element is started displaying in a region of the message triggering element. A numerical mark in the message quantity element indicates a message quantity sum of currently received social messages (for example, a message quantity sum of social messages transmitted from the second social account).

As shown in FIG. 9, the social message transmitted from the second social account is received for the first time and 16 social messages are transmitted from the second social account, and a message quantity element 920 is displayed at an upper right corner of the message triggering element 910. The message quantity element 920 includes a numerical mark “16”, indicating that a message quantity sum of the currently received social messages is 16.

In some embodiments, if a social message transmitted from another associated account is currently received, for example, a message quantity element is currently displayed in a region of the message triggering element, when the social message transmitted from the second social account is received, the message quantity element is updated and displayed. An updated numerical mark includes a sum of a quantity of social messages previously received and a quantity of the social messages transmitted from the second social account. For example, if 10 social messages are currently received, the message quantity element is displayed as “10”. After 5 social messages transmitted from the second social account are received, the message quantity element may be updated and displayed as “15”.

In some embodiments, if a social message transmitted from an associated account is read, the message quantity element is updated and displayed. The numerical mark in the updated message quantity element is reduced by a message quantity corresponding to social messages that are read. For example, if the message quantity element is currently displayed as “20”, and three social messages transmitted from an associated account a are read, the message quantity element is updated and displayed as “17”.

Operation 840: Display a message carrying bar in response to receiving a triggering operation performed on the message triggering element.

The message carrying bar indicates that the social message transmitted from the associated account is received, and the message carrying bar includes a message prompt element, an account identification element, and a positioning mark element corresponding to the second social account.

The message carrying bar is configured for carrying and displaying a message prompt element and an account identification element corresponding to at least one associated account from which a social message is transmitted. If a virtual social object corresponding to the associated account is in the virtual scene, a positioning mark element is displayed at a position of an account identification element corresponding to the associated account. If the virtual social object corresponding to the associated account is not in the virtual scene, the positioning mark element is not displayed.

In some embodiments, when a clicking/tapping operation performed on the message triggering element as a triggering operation is received, the message carrying bar is displayed in the scene picture corresponding to the virtual scene.

In some embodiments, when a dragging operation performed on the message triggering element as a triggering operation is received, the message carrying bar is displayed in the scene picture corresponding to the virtual scene.

In some embodiments, the message carrying bar is displayed in a fixed display length in the scene picture corresponding to the virtual scene. The display length of the message carrying bar increases with an increase of a quantity of associated accounts from which social messages are transmitted (or decreases with cancellation of display of associated accounts corresponding to social messages that are read after the social messages are read). The display length of the message carrying bar may be related to a quantity of associated accounts corresponding to currently received and unread social messages.

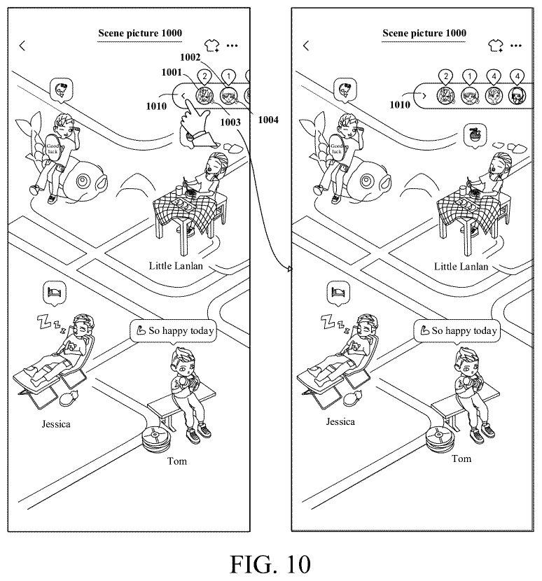

FIG. 10 is a schematic diagram of a message carrying bar according to some embodiments. As shown in FIG. 10, a scene picture 1000 corresponding to the virtual scene is currently displayed in the first observation range, and a message triggering element is displayed in the scene picture 1000. When a triggering operation performed on the message triggering element is received, a message carrying bar 1010 is gradually displayed. In addition, since social messages transmitted from a plurality of associated accounts are received, a display length of the message carrying bar 1010 gradually increases (the message carrying bar switches from complete display of account identification elements, message prompt elements, and positioning mark elements respectively corresponding to two associated accounts to complete display of account identification elements and message prompt elements respectively corresponding to four associated accounts, with a positioning mark element 1003 and a positioning mark element 1004 being respectively displayed in ranges of an account identification element 1001 and an account identification element 1002, indicating that virtual social objects corresponding to associated accounts respectively corresponding to the account identification element 1001 and the account identification element 1002 are in the virtual scene).

In some embodiments, if a triggering operation is performed on the displayed message carrying bar, the message triggering bar may be recovered to be displayed as the message triggering element.

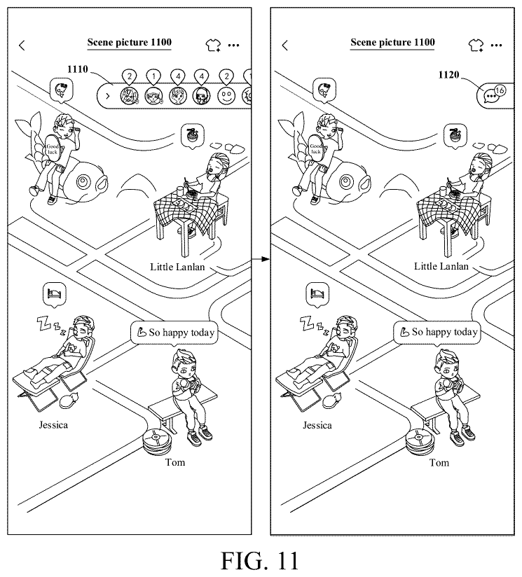

FIG. 11 is a schematic diagram of element display switching according to some embodiments. As shown in FIG. 11, a scene picture 1100 corresponding to the virtual scene is currently displayed in the first observation range, and a message carrying bar 1110 is displayed in the scene picture 1100. When a triggering operation performed on the message carrying bar 1110 is received, the message carrying bar 1110 is switched to be displayed as a message triggering element 1120.

In this embodiment, when the social message transmitted from the second social account is received, the message prompt element and the account identification element corresponding to the second social account are displayed in the message carrying bar, and since the second social object corresponding to the second social account is in the virtual scene, the positioning mark element is displayed at the position of the account identification element corresponding to the second social account.

Operation 850: Hide, in response to receiving a social message transmitted from a third social account, and a quantity of account identification elements displayed in the message carrying bar reaching a quantity threshold, an account identification element corresponding to the third social account.

In this embodiment, a description is provided by using an example in which the display length of the message carrying bar varies.

In some embodiments, a quantity threshold is set for a quantity of account identification elements simultaneously displayed in the message carrying bar. After the quantity of account identification elements displayed in the message carrying bar reaches the quantity threshold, and the social message transmitted from the associated account is subsequently received, relevant elements (an account identification element and a message prompt element) corresponding to the associated account are hidden. In some embodiments, after the quantity of account identification elements displayed in the message carrying bar reaches the quantity threshold, and the social message transmitted from the associated account is subsequently received, relevant elements (an account identification element and a message prompt element) of an associated account corresponding to a first received social message are hidden.

In this embodiment, after the social message transmitted from the third social account is received, since a quantity of account identification elements currently displayed in the message carrying bar reaches the quantity threshold (the quantity threshold in this embodiment is “4”), the account identification element and a message prompt element corresponding to the third social account are hidden. If a third social object corresponding to the third social account is in the virtual scene, a positioning mark element corresponding to the third social account is hidden.

In some embodiments, an extended region corresponding to the message carrying bar is displayed in response to receiving a dragging operation performed on the message carrying bar. The extended region includes the message prompt element and the account identification element corresponding to the third social account.

In this embodiment, although the account identification element corresponding to the third social account is currently hidden, the account identification element corresponding to the third social account is actually located in the extended region of the message carrying bar. Therefore, a dragging operation may be performed on the message carrying bar. Through the dragging operation, the extended region of the message carrying bar can be displayed, for example, the account identification element corresponding to the third social account in the extended region is displayed.

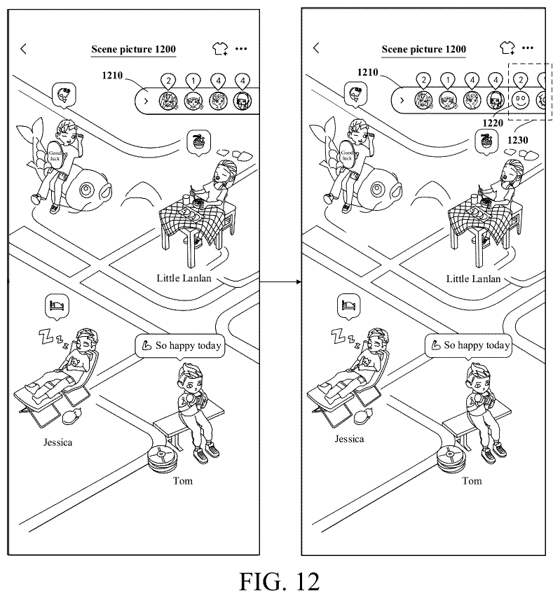

FIG. 12 is a schematic diagram of hiding according to some embodiments. As shown in FIG. 12, a scene picture 1200 corresponding to the virtual scene is currently displayed in the first observation range. A message carrying bar 1210 is displayed in the scene picture 1200. Four account identification elements are currently displayed in the message carrying bar 1210. A quantity of account identification elements reaches the quantity threshold. After the social message transmitted from the third social account is received, since the quantity of the account identification elements currently displayed in the message carrying bar 1210 reaches the quantity threshold, an account identification element 1220 corresponding to the third social account is hidden. When a dragging operation performed on the message carrying bar 1210 is received, an extended region 1230 is displayed. The account identification element 1220 corresponding to the third social account is displayed in the extended region 1230.

In some embodiments, after the extended region is displayed in the message carrying bar, if no account identification element exists in the extended region after a triggering operation is performed on a message prompt element displayed in the extended region and a relevant social message is read, the extended region automatically retracts. The extended region does not automatically retract after being displayed in the message carrying bar, but manual retraction may be achieved through a dragging operation.

Operation 860: Switch from the first observation range to a second observation range based on a positioning mark element to display a scene picture corresponding to the virtual scene in response to receiving a triggering operation performed on the account identification element.

A virtual scene in the second observation range includes the second social object.

In this embodiment, when a triggering operation performed on the account identification element corresponding to the second social account is received, the switching from the first observation range to the second observation range is performed based on the positioning mark element, and the scene picture corresponding to the virtual scene is displayed in the second observation range. The second social object is displayed at a middle position of the scene picture corresponding to the virtual scene displayed in the second observation range.

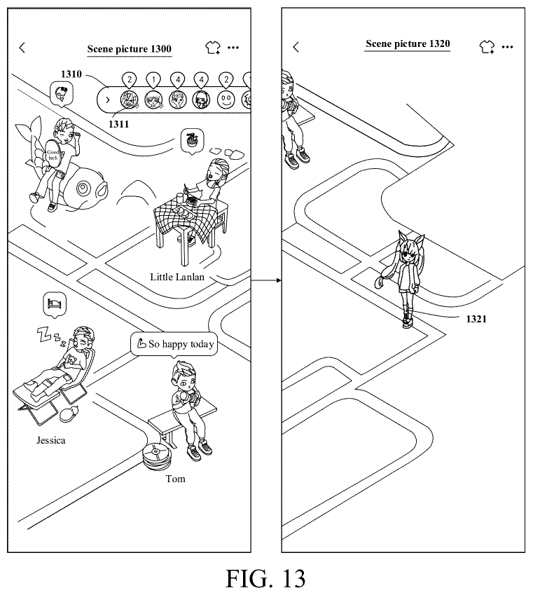

FIG. 13 is a schematic diagram of observation range switching according to some embodiments. As shown in FIG. 13, a scene picture 1300 corresponding to the virtual scene is currently displayed in the first observation range. A message carrying bar 1310 is displayed in the scene picture 1300. An account identification element 1311 corresponding to the second social account is displayed in the message carrying bar. When a triggering operation performed on the account identification element 1311 is received, a scene switching animation presenting the switching from the first observation range to the second observation range is displayed. Finally, a scene picture 1320 corresponding to the virtual scene is displayed in the second observation range. A second social object 1321 is displayed at a middle position of the scene picture 1320.

In some embodiments, in response to receiving a social message transmitted from a fourth social account, a message prompt element and an account identification element corresponding to the fourth social account are displayed, and in response to receiving a triggering operation performed on the account identification element and a fourth social object corresponding to the fourth social account being outside the virtual scene, an account content interface is displayed. The account content interface includes the fourth social object.

In this embodiment, a case that a virtual social object corresponding to an associated account is outside the virtual scene exists. Therefore, when the social message transmitted from the fourth social account corresponding to the virtual social object outside the virtual scene is received, and the quantity of account identification elements displayed in the message carrying bar does not reach the quantity threshold, the account identification element and the message prompt element corresponding to the fourth social account are displayed in the message carrying bar, but a positioning mark element is not displayed. After the triggering operation performed on the account identification element is received, the account content interface corresponding to the fourth social account is displayed. The account content interface includes the fourth social object corresponding to the fourth social account. The account content interface is configured to display account information corresponding to the fourth social account. The account information includes at least one of an account name, an account dynamic, and account interaction information (a quantity of followees, a quantity of followers, a quantity of likes, and the like).

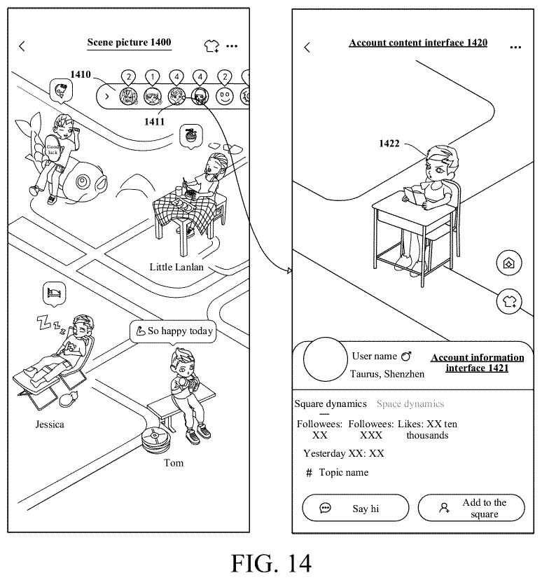

FIG. 14 is a schematic diagram of an account content interface according to some embodiments. As shown in FIG. 14, a scene picture 1400 corresponding to the virtual scene is currently displayed in the first observation range. A message carrying bar 1410 is displayed in the scene picture 1400. An account identification element 1411 corresponding to the fourth social account is displayed in the message carrying bar 1410. When a triggering operation performed on the account identification element 1411 is received, an account content interface 1420 is displayed. The account content interface 1420 includes an account information interface 1421 and a fourth social object 1422.

In summary, according to the method for displaying a message based on a social scene provided in some embodiments, during the display of the scene picture corresponding to the virtual scene in the first observation range, when the social message transmitted from the second social account is received, the message prompt element and the account identification element corresponding to the second social account are displayed; since the second social object corresponding to the second social account is in the virtual scene, the positioning mark element is displayed at the position of the account identification element; and when the triggering operation performed on the account identification element is received, and the switching from the first observation range to the second observation range including the second social object is performed based on the positioning mark element, to display the scene picture. When the social message transmitted from the social account of the virtual social object in the virtual scene is received, the positioning mark element may be displayed to notify a user that the virtual social object is currently in the virtual scene, so as to implement automatic switching from a current observation range to an observation range corresponding to the virtual social object based on the positioning mark element. Indication functions of a message may be increased, thereby improving display efficiency of the message. In addition, the automatic switching function avoids a manual operation of the user, reducing data overheads of computers.

In this embodiment, the display of the message triggering element and the display of the message quantity element can prompt the user a quantity sum of all currently received and unread social messages, thereby improving element display efficiency and diversity.

In this embodiment, through the display of the message carrying bar and display of elements corresponding to all social accounts from which social messages in the message carrying bar are transmitted, arrangement of the elements can be more unified, thereby improving an aesthetic degree.

In this embodiment, elements of a social account corresponding to a social message subsequently received are hidden when the quantity of account identification elements displayed in the message carrying bar reaches the quantity threshold, so that infinite extension of the message carrying bar can be prevented, and the extended region can be displayed through a dragging operation, thereby displaying hidden elements. Display flexibility of the message carrying bar may be improved, thereby improving an aesthetic degree of the display.

In this embodiment, through a triggering operation performed on an account identification element of an associated account corresponding to the virtual social object that is not in the virtual scene, an account content interface corresponding to the associated account is displayed, so that the user can subsequently add the virtual social object corresponding to the associated account to the virtual scene, thereby improving interactivity of the virtual object.

In the solutions provided in some embodiments, the “account identification element” and the “message prompt element” are displayed corresponding to each other and simultaneously. Therefore, even if only the “account identification element” is described, the “message prompt element” corresponding thereto also exists. In addition, if the associated account is a social account with a virtual social object in a virtual scene, the “positioning mark element” is displayed together at the position of the “account identification element”. The explanation is no longer repeated subsequently.

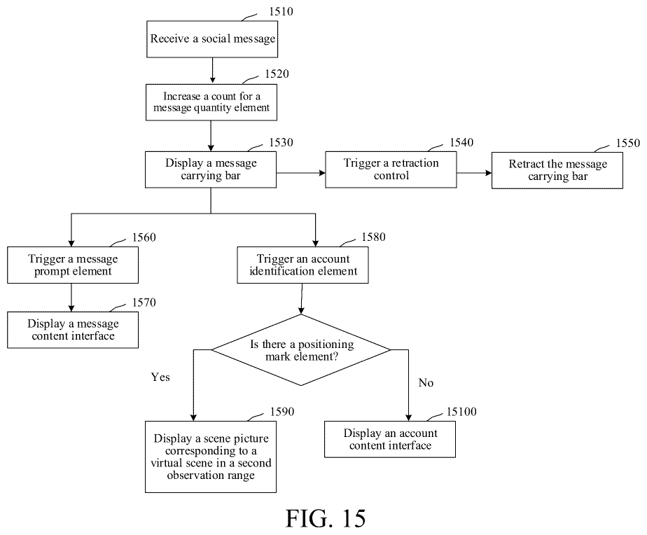

In some embodiments, a description is provided by using an example in which the method for displaying a message based on a social scene is applied to a social game. FIG. 15 is a flowchart of a method for displaying a message based on a social scene according to some embodiments. As shown in FIG. 15, the method includes the following operations.

Operation 1510: Receive a social message.

A scene picture corresponding to a virtual scene is displayed in a first observation range. The virtual scene includes virtual social objects respectively corresponding to a plurality of social accounts.

3 social messages transmitted from a second social account are currently received. A social message is transmitted in a target application from the second social account to a first social account corresponding to the virtual scene, or the social message is transmitted on another social platform from the second social account to the first social account. An application corresponding to the another social platform is an application having an association relationship with the target application, or the application corresponding to the another social platform is a subprogram of the target application.

Operation 1520: Increase a count for a message quantity element.

Since no social message transmitted from another associated account is currently received, a message triggering element is displayed in the scene picture as a message entry. A message quantity element “3” is displayed at a position of the message triggering element, to indicate that a quantity sum of currently received and unread social messages is 3. If a social message transmitted from another associated account is subsequently received, a count is increased based on the message quantity element “3” (for example, if 4 social messages transmitted from the another associated account are subsequently received, the message quantity element is updated and displayed as “7”).

Operation 1530: Display a message carrying bar.

The message carrying bar is displayed when a clicking/tapping operation or a dragging operation performed on the message triggering element is received.

The message carrying bar is configured to carry and display an account identification element and a message prompt element corresponding to a received and unread social message.

Operation 1540: Trigger a retraction control.

The message carrying bar further includes the retraction control. The retraction control is configured to recover the message carrying bar to be displayed as the message triggering element. If a triggering operation performed on the retraction control is received, operation 1550 is performed. If no triggering operation is performed on the retraction control, operation 1560 is performed.

Operation 1550: Retract the message carrying bar.

When the triggering operation performed on the retraction control is received, the message carrying bar is retracted, and the message triggering element is recovered and displayed.

Operation 1560: Trigger a message prompt element.

The message prompt element is configured for triggering display of message content corresponding to the social message. A triggering operation performed on a message prompt element corresponding to the second social account is received.

Operation 1570: Display a message content interface.

A message content interface corresponding to the social message transmitted from the second social account is displayed based on the triggering operation performed on the message prompt element corresponding to the second social account by a user. The message content interface includes message content corresponding to the social message transmitted from the second social account.

Operation 1580: Trigger an account identification element.

In addition to the triggering operation performed on the message prompt element, a triggering operation may be further performed on an account identification element corresponding to the second social account.

When the triggering operation performed on the account identification element corresponding to the second social account is received, it is determined whether a positioning mark element is currently displayed. If the positioning mark element is displayed at a position of the account identification element, operation 1590 is performed. If no positioning mark element is displayed at the position of the account identification element, operation 15100 is performed.

The positioning mark element is configured for determining that whether a virtual social object corresponding to the associated account is in the virtual scene. If a second social object corresponding to the second social account is not in the virtual scene, the positioning mark element is not displayed. If the second social object corresponding to the second social account is in the virtual scene, the positioning mark element is displayed at the position of the account identification element corresponding to the second social account.

Operation 1590: Display a scene picture corresponding to the virtual scene in a second observation range.

In a case that the second social object corresponding to the second social account is in the virtual scene, the display is switched from the first observation range to the second observation range, and the scene picture corresponding to the virtual scene is displayed in the second observation range. The second social object corresponding to the second social account is displayed at a middle position of the scene picture corresponding to the virtual scene in the second observation range.

Operation 15100: Display an account content interface.

In a case that the second social object corresponding to the second social account is not in the virtual scene, an account content interface corresponding to the second social account is displayed. The account content interface is configured to display account information of the second social account, including displaying the second social object corresponding to the second social account.

In summary, according to the method for displaying a message based on a social scene provided in some embodiments, during the display of the scene picture corresponding to the virtual scene in the first observation range, when the social message transmitted from the second social account is received, the message prompt element and the account identification element corresponding to the second social account are displayed; since the second social object corresponding to the second social account is in the virtual scene, the positioning mark element is displayed at the position of the account identification element; and when the triggering operation performed on the account identification element is received, and the switching from the first observation range to the second observation range including the second social object is performed based on the positioning mark element, to display the scene picture. When the social message transmitted from the social account of the virtual social object in the virtual scene is received, the positioning mark element may be displayed to notify a user that the virtual social object is currently in the virtual scene, so as to implement automatic switching from a current observation range to an observation range corresponding to the virtual social object based on the positioning mark element. Indication functions of a message may be increased, thereby improving display efficiency of the message. In addition, the automatic switching function avoids a manual operation of the user, reducing data overheads of computers.

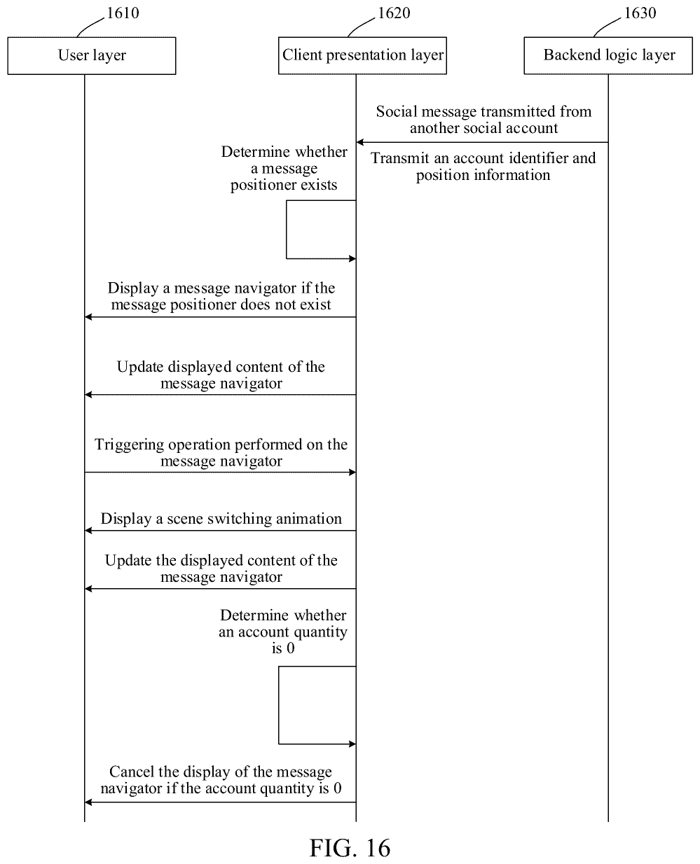

FIG. 16 is an interaction diagram of a method for displaying a message based on a social scene according to some embodiments. As shown in FIG. 16, the method includes the following content.

A current timing diagram includes a user layer 1610, a client presentation layer 1620, and a backend logic layer 1630. The user layer 1610 is implemented as picture content displayed by a terminal device to a user, the client presentation layer 1620 is configured to render a value generated by the server on an interface of the terminal device, and the backend logic layer 1630 is configured to perform code setting and processing.

After receiving social messages transmitted from another associated account having an association relationship with a first social account, the backend logic layer 1630 determines a social message quantity and scene mark elements (an account identification element and a message prompt element, where if the virtual social object corresponding to the associated account is in a virtual scene, a positioning mark element is further included; or otherwise, the positioning mark element is not included) corresponding to the associated account, and transmits the social message quantity and the scene mark elements to the client presentation layer 1620.

The client presentation layer 1620 displays, in the scene picture based on the received social message quantity, a message quantity element updated and displayed at a position of a message triggering element to the user layer 1610, so that an increment of a numerical mark of the message quantity element is in consistent with the received social message quantity.

A player may perform a clicking/tapping operation or a dragging operation on the message triggering element through the user layer 1610. The clicking/tapping operation or the dragging operation is transmitted to the client presentation layer 1620. The client presentation layer 1620 displays a message carrying bar to the user layer 1610 based on the clicking/tapping operation or the dragging operation. The message carrying bar displays account identification elements and message prompt elements corresponding to a plurality of associated accounts corresponding to received and unread social messages.

The player may perform a triggering operation on a message prompt element corresponding to a target account of the plurality of associated accounts through the user layer 1610. The user layer 1610 transmits the triggering operation to the client presentation layer 1620. The client presentation layer 1620 transmits a content display request to the backend logic layer 1630 based on the triggering operation. The content display request is configured for requesting display of message content corresponding to a social message transmitted from the target account. The backend logic layer 1630 feeds back, based on the received content display request, the content data corresponding to the social message transmitted from the target account to the client presentation layer 1620. The client presentation layer 1620 displays, to the user layer 1620, a picture presenting opening of a message content interface and loading of the message content. After the loading of the message content interface is completed, the message content corresponding to the social message is displayed.

The player may perform a triggering operation on an account identification element corresponding to the target account of the plurality of associated accounts through the user layer 1610. The user layer 1610 determines whether a positioning mark element exists at a position corresponding to the account identification element corresponding to the target account based on the triggering operation. If the positioning mark element exists, switching from a first observation range to a second observation range is displayed to the user layer 1610, and a scene picture corresponding to the virtual scene is displayed in the second observation range. A second social object is displayed in the picture. If the positioning mark element exists, an account content display request is transmitted to the backend logic layer 1630. The account content display request is configured for displaying an account content interface corresponding to the target account. The backend logic layer 1630 feeds back account content link information corresponding to the target account to the client presentation layer 1620 based on the received account content display request. The client presentation layer 1620 displays the account content interface corresponding to the target account to the user layer 1610 based on the account content link information. The account content interface includes account information corresponding to the target account and a virtual social object corresponding to the target account.

In summary, according to the method for displaying a message based on a social scene provided in some embodiments, during the display of the scene picture corresponding to the virtual scene in the first observation range, when the social message transmitted from the second social account is received, the message prompt element and the account identification element corresponding to the second social account are displayed; since the second social object corresponding to the second social account is in the virtual scene, the positioning mark element is displayed at the position of the account identification element; and when the triggering operation performed on the account identification element is received, and the switching from the first observation range to the second observation range including the second social object is performed based on the positioning mark element, to display the scene picture. When the social message transmitted from the social account of the virtual social object in the virtual scene is received, the positioning mark element may be displayed to notify a user that the virtual social object is currently in the virtual scene, so as to implement automatic switching from a current observation range to an observation range corresponding to the virtual social object based on the positioning mark element. Indication functions of a message may be increased, thereby improving display efficiency of the message. In addition, the automatic switching function avoids a manual operation of the user, reducing data overheads of computers.

In the method for displaying a message based on a social scene provided in this application, more abundant and processing functions can be achieved for an unread message. A conversation interface may be opened, and different feedback may be provided based on different positions of a virtual object. A conversation function may be effectively combined with a virtual scene, thereby improving social immersion. Therefore, existing message experience is significantly upgraded.

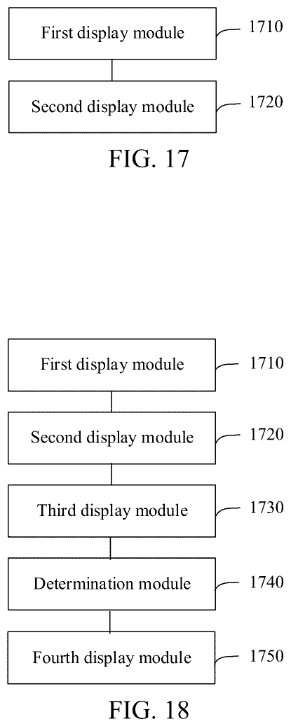

FIG. 17 is a structural block diagram of an apparatus for displaying a message based on a social scene according to some embodiments. As shown in FIG. 17, the apparatus includes:
a first display module 1710, configured to display a scene picture corresponding to a virtual scene in a first observation range, the virtual scene including virtual social objects respectively corresponding to a plurality of social accounts, the virtual social objects including a first social object corresponding to a first social account logged in with the terminal device,
the first display module 1710 being further configured to display, in response to receiving a social message transmitted from a second social account, a message prompt element and an account identification element corresponding to the second social account, the message prompt element being configured for triggering display of message content of the social message;
the first display module 1710 being further configured to display a positioning mark element at a position corresponding to the account identification element in response to a second social object corresponding to the second social account being in the virtual scene, the positioning mark element indicating that the second social object is in the virtual scene; and
a second display module 1720, configured to switch from the first observation range to a second observation range based on the positioning mark element to display the scene picture corresponding to the virtual scene in response to receiving a triggering operation performed on the account identification element, the virtual scene in the second observation range including the second social object.

In some embodiments, the first display module 1710 is further configured to: obtain a target position of the second social object in the virtual scene; and display the positioning mark element at the position corresponding to the account identification element based on the target position, the positioning mark element including a direction indication element, and the direction indication element indicating an orientation relationship between the target position and the scene picture corresponding to the virtual scene displayed in the first observation range.

In some embodiments, the first display module 1710 is further configured to: obtain a target position of the second social object in the virtual scene; obtain a region division result corresponding to the virtual scene, the region division result including a plurality of candidate scene regions corresponding to the virtual scene; obtain a target scene region corresponding to the target position from the plurality of candidate scene regions based on the target position; and display the positioning mark element at the position corresponding to the account identification element based on the target scene region, the positioning mark element including a region indication element corresponding to the target scene region.

In some embodiments, an element display size of the on the positioning mark element is related to a distance between the second social object and the scene picture corresponding to the virtual scene displayed in the first observation range.

In some embodiments, as shown in FIG. 18, the apparatus further includes:
a third display module 1730, configured to display a message content interface in response to receiving a triggering operation performed on the message prompt element, the message content interface including the message content corresponding to the social message.

In some embodiments, message prompt elements and account identification elements respectively corresponding to a plurality of social accounts from which the social message is transmitted are displayed in the scene picture corresponding to the virtual scene displayed in the first observation range.

The apparatus further includes:
a determination module 1740, configured to determine, in response to successively receiving triggering operations performed on a plurality of message prompt elements, a triggering order corresponding to the plurality of message prompt elements.

The third display module 1730 is further configured to display a message content interface corresponding to the first triggering operation in the triggering order, an (n+1)^{th} message content interface being hidden immediately after an n^{th} message content interface, n≥1, and n being an integer.

The third display module 1730 is further configured to display the (n+1)^{th} message content interface in response to receiving a sliding operation performed on the n^{th} message content interface.

In some embodiments, the first display module 1710 is further configured to: display a message triggering element; display a message quantity element in a region of the message triggering element in response to receiving the social message transmitted from the second social account, the message quantity element indicating a message quantity sum of currently received social messages transmitted from an associated account, the associated account being an account having an association relationship with the first social account; and display a message carrying bar in response to receiving a triggering operation performed on the message triggering element, the message carrying bar indicating that the social messages transmitted from the associated account are received, and the message carrying bar including the message prompt element, the account identification element, and the positioning mark element corresponding to the second social account.

In some embodiments, the first display module 1710 is further configured to hide, in response to receiving a social message transmitted from a third social account, and a quantity of account identification elements displayed in the message carrying bar reaching a quantity threshold, an account identification element corresponding to the third social account.

In some embodiments, the first display module 1710 is further configured to display an extended region corresponding to the message carrying bar in response to receiving a dragging operation performed on the message carrying bar, the extended region including a message prompt element and the account identification element corresponding to the third social account.

In some embodiments, the apparatus further includes:
a fourth display module 1750, configured to: display, in response to receiving a social message transmitted from a fourth social account, a message prompt element and an account identification element corresponding to the fourth social account; and display an account content interface in response to receiving a triggering an account content interface in response to receiving a triggering operation performed on the account identification element, and a fourth social object corresponding to the fourth social account being outside the virtual scene, the account content interface including the fourth social object.

In summary, according to the apparatus for displaying a message based on a social scene provided in some embodiments, during the display of the scene picture corresponding to the virtual scene in the first observation range, when the social message transmitted from the second social account is received, the message prompt element and the account identification element corresponding to the second social account are displayed; since the second social object corresponding to the second social account is in the virtual scene, the positioning mark element is displayed at the position of the account identification element; and when the triggering operation performed on the account identification element is received, and the switching from the first observation range to the second observation range including the second social object is performed based on the positioning mark element, to display the scene picture. When the social message transmitted from the social account of the virtual social object in the virtual scene is received, the positioning mark element may be displayed to notify a user that the virtual social object is currently in the virtual scene, so as to implement automatic switching from a current observation range to an observation range corresponding to the virtual social object based on the positioning mark element. Indication functions of a message may be increased, thereby improving display efficiency of the message. In addition, the automatic switching function avoids a manual operation of the user, reducing data overheads of computers.

For the apparatus for displaying a message based on a social scene provided in the above embodiment, division of the functional modules may be exemplified. In an actual application, the functions may be assigned to different functional modules for completion as required. An internal structure of the device may be divided into different functional modules to complete all or some of the functions described above. In addition, the apparatus for displaying a message based on a social scene provided in the above embodiment belongs to the same idea as the method for displaying a message based on a social scene. For implementation details, reference may be made to the descriptions of the method according to some embodiments.

According to some embodiments, each module may exist respectively or be combined into one or more modules. Some modules may be further split into multiple smaller function subunits, thereby implementing the same operations without affecting the technical effects of some embodiments. The modules are divided based on logical functions. In actual applications, a function of one module may be realized by multiple modules, or functions of multiple modules may be realized by one module. In some embodiments, the apparatus may further include other modules. In actual applications, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding unit.

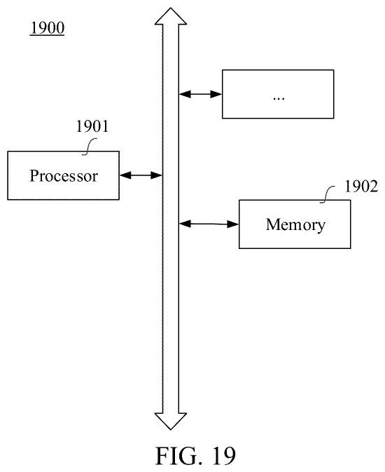

FIG. 19 is a structural block diagram of a terminal device 1900 according to some embodiments. The terminal device 1900 may be a smartphone, a tablet computer, an MP3 player, an MP4 player, a notebook computer, or a desktop computer. The terminal device 1900 may also be referred to as another name such as a user equipment, a portable terminal device, a laptop terminal device, or a desktop terminal device.

The terminal device 1900 may include a processor 1901 and a memory 1902.

The processor 1901 may include one or more processing cores, for example, a 4-core processor or an 8-core processor. The processor 1901 may be implemented by using at least one of the following hardware forms: a digital signal processor (DSP), a field-programmable gate array (FPGA), and a programmable logic array (PLA). The processor 1901 may include a main processor and a coprocessor. The main processor is a processor configured to process data in a wake-up state, and is also referred to as a central processing unit (CPU). The coprocessor is a low power consumption processor configured to process data in a standby state. In some embodiments, the processor 1901 may have a graphics processing unit (GPU) integrated therein. The GPU is configured to render and draw content to be displayed. In some embodiments, the processor 1901 may further include an artificial intelligence (AI) processor. The AI processor is configured to process computing operations related to machine learning.

The memory 1902 may include one or more computer-readable storage media. The computer-readable storage medium may be non-transient. The memory 1902 may further include a high-speed random access memory (RAM) and a non-volatile memory, for example, one or more disk storage devices and flash storage devices. In some embodiments, the non-transient computer-readable storage medium in the memory 1902 is configured to store at least one instruction. The at least one instruction is configured to be executed by the processor 1901 to implement the method for displaying a message based on a social scene provided in the method according to some embodiments.

In some embodiments, the terminal device 1900 further includes other components. A person skilled in the art may understand that the structure shown in FIG. 19 does not constitute a limitation on the terminal device 1900. The terminal device may include more or fewer components than those shown in the figure, or some merged components, or different component arrangements.

A person of ordinary skill in the art may understand that all or some of the operations of the methods in the above embodiments may be implemented by instructing relevant hardware through a program. The program may be stored in a computer-readable storage medium. The computer-readable storage medium may be the computer-readable storage medium included in the memory in the above embodiment, or may be a computer-readable storage medium that exists alone and is not installed in the terminal device. The computer-readable storage medium has at least one instruction, at least one program, a code set, or an instruction set stored therein. The at least one instruction, the at least one program, the code set, or the instruction set is loaded and executed by the processor to perform the method for displaying a message based on a social scene provided according to some embodiments.

The at least one instruction, the at least one program, the code set, or the instruction set may be collectively referred to as a computer program or a program.

In some embodiments, the computer-readable storage medium may include a read-only memory (ROM), a RAM, a solid state drive (SSD), an optical disc, or the like. The RAM may include a resistance random access memory (ReRAM) and a dynamic random access memory (DRAM). The serial numbers of the above embodiments are for description, and do not represent preference of the embodiments.

A person of ordinary skill in the art may understand that all or some of the operations implementing the above embodiments may be implemented by hardware, or may be implemented by instructing related hardware through a program. The program may be stored in a computer-readable storage medium. The storage medium may be a ROM, a disk, an optical disc, or the like.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A method for displaying a message based on a social scene, performed by a terminal device, comprising:
displaying a first scene picture corresponding to a virtual scene in a first observation range, the virtual scene comprising a plurality of virtual social objects that correspond to a plurality of social accounts, wherein the plurality of virtual social objects comprise a first social object corresponding to a first social account logged in with the terminal device;
displaying, based on receiving a first social message transmitted from a second social account, a first message prompt element and a first account identification element corresponding to the second social account, the first message prompt element being configured for triggering display of message content of the first social message;
displaying, based on a second social object corresponding to the second social account being in the virtual scene, a positioning mark element at a determined position corresponding to the first account identification element, wherein the positioning mark element indicates the second social object is in the virtual scene; and
switching, based on the positioning mark element, from the first observation range to a second observation range, to display a second scene picture corresponding to the virtual scene based on a first triggering operation being performed on the first account identification element,
wherein the virtual scene comprises the second social object in the second observation range.

2. The method according to claim 1, wherein the displaying the positioning mark element comprises:
obtaining a target position of the second social object in the virtual scene;
displaying the positioning mark element at the determined position based on the target position,
wherein the positioning mark element comprising a direction indication element, and
wherein the direction indication element indicating an orientation relationship between the target position and the first scene picture.

3. The method according to claim 1, wherein the displaying the positioning mark element comprises:
obtaining a target position of the second social object in the virtual scene;
obtaining a region division result corresponding to the virtual scene, comprising a plurality of candidate scene regions corresponding to the virtual scene;
obtaining a target scene region corresponding to the target position from the plurality of candidate scene regions based on the target position; and
displaying the positioning mark element at the determined position based on the target scene region, the positioning mark element comprising a region indication element corresponding to the target scene region.

4. The method according to claim 1, wherein an element display size of the positioning mark element is related to a distance between the second social object and the first scene picture.

5. The method according to claim 1, wherein after the displaying the first message prompt element and the first account identification element, the method further comprises:
displaying a first message content interface in response to receiving a second triggering operation performed on the first message prompt element, the first message content interface comprising the message content corresponding to the first social message.

6. The method according to claim 5, wherein message prompt elements and account identification elements are displayed in the first scene picture; and
the method further comprises:
determining, in response to successively receiving triggering operations performed on a plurality of message prompt elements, a triggering order corresponding to the plurality of message prompt elements;
displaying a second message content interface corresponding to the first triggering operation in the triggering order, a third message content interface being hidden immediately after the second message content interface; and
displaying the third message content interface in response to receiving a sliding operation performed on the second message content interface.

7. The method according to claim 1, further comprising:
displaying a message triggering element;
displaying, based on receiving the first social message transmitted from the second social account, a message quantity element indicating a quantity of social messages received from an associated account that has an association relationship with the first social account; and
displaying, based on receiving a triggering operation performed on the message triggering element, a message carrying bar indicating that the social messages are received, the message carrying bar comprising the first message prompt element, the first account identification element, and the positioning mark element corresponding to the second social account.

8. The method according to claim 1, further comprising hiding a second account identification element corresponding to a third social account, based on:
receiving a second social message transmitted from the third social account, and
a quantity of account identification elements displayed in a message carrying bar reaching a threshold.

9. The method according to of claim 8, wherein after the hiding the second account identification element, the method further comprises:
displaying, based on receiving a dragging operation performed on the message carrying bar, an extended region comprising a second message prompt element and the second account identification element.

10. The method according to claim 1, further comprising:
displaying, based on receiving a social message transmitted from a fourth social account, a second message prompt element and a second account identification element corresponding to the fourth social account; and
displaying an account content interface based on:
a triggering operation being performed on the second account identification element, and
a fourth social object corresponding to the fourth social account being outside the virtual scene,
wherein the account content interface comprises the fourth social object.

11. An apparatus for displaying a message based on a social scene, the apparatus comprising:
at least one memory configured to store computer program code; and
at least one processor configured to read the program code and operate as instructed by the program code, the program code comprising:
scene picture code configured to cause at least one of the at least one processor to display a first scene picture corresponding to a virtual scene in a first observation range, the virtual scene comprising a plurality of virtual social objects that correspond to a plurality of social accounts, wherein the plurality of virtual social objects comprise a first social object corresponding to a first social account logged in with a terminal device;
message prompt code configured to cause at least one of the at least one processor to display, based on receiving a first social message transmitted from a second social account, a first message prompt element and a first account identification element corresponding to the second social account, the first message prompt element being configured for triggering display of message content of the first social message;
positioning mark code configured to cause at least one of the at least one processor to display, based on a second social object corresponding to the second social account being in the virtual scene, a positioning mark element at a determined position corresponding to the first account identification element, wherein the positioning mark element indicates the second social object is in the virtual scene; and
switching code configured to cause at least one of the at least one processor to switch, based on the positioning mark element, from the first observation range to a second observation range, to display a scene picture corresponding to the virtual scene in response to receiving a first triggering operation performed on the first account identification element,
wherein the virtual scene comprises the second social object in the second observation range.

12. The apparatus according to claim 11, wherein the positioning mark code is configured to cause at least one of the at least one processor to:
obtain a target position of the second social object in the virtual scene;
display the positioning mark element at the determined position based on the target position,
wherein the positioning mark element comprising a direction indication element, and
wherein the direction indication element indicating an orientation relationship between the target position and the first scene picture.

13. The apparatus according to claim 11, wherein the positioning mark code is configured to cause at least one of the at least one processor to:
obtain a target position of the second social object in the virtual scene;
obtain a region division result corresponding to the virtual scene, comprising a plurality of candidate scene regions corresponding to the virtual scene;
obtain a target scene region corresponding to the target position from the plurality of candidate scene regions based on the target position; and
display the positioning mark element at the determined position based on the target scene region, the positioning mark element comprising a region indication element corresponding to the target scene region.

14. The apparatus according to claim 11, wherein an element display size of the positioning mark element is related to a distance between the second social object and the first scene picture.

15. The apparatus according to claim 11, wherein the program code further comprises message content interface code configured to cause at least one of the at least one processor to display a first message content interface in response to receiving a second triggering operation performed on the first message prompt element, the first message content interface comprising the message content corresponding to the first social message.

16. The apparatus according to claim 15, wherein the scene picture code is configured to cause at least one of the at least one processor to display message prompt elements and account identification elements in the first scene picture, and
wherein the message content interface code is further configured to cause at least one of the at least one processor to:
determine, in response to successively receiving triggering operations performed on a plurality of message prompt elements, a triggering order corresponding to the plurality of message prompt elements;
display a second message content interface corresponding to the first triggering operation in the triggering order, a third message content interface being hidden immediately after the second message content interface; and
display the third message content interface in response to receiving a sliding operation performed on the second message content interface.

17. The apparatus according to claim 11, wherein the program code further comprises message triggering code configured to cause at least one of the at least one processor to:
display a message triggering element;
display, based on receiving the first social message transmitted from the second social account, a message quantity element indicating a quantity of social messages received from an associated account that has an association relationship with the first social account; and
display, based on receiving a triggering operation performed on the message triggering element, a message carrying bar indicating that the social messages are received, the message carrying bar comprising the first message prompt element, the first account identification element, and the positioning mark element corresponding to the second social account.

18. The apparatus according to claim 11, wherein the program code further comprises first hiding code configured to cause at least one of the at least one processor to hide a second account identification element corresponding to a third social account, based on:
receiving a second social message transmitted from the third social account, and
a quantity of account identification elements displayed in a message carrying bar reaching a threshold.

19. The apparatus according to of claim 18, wherein the program code further comprises second hiding code configured to cause at least one of the at least one processor to display, based on receiving a dragging operation performed on the message carrying bar, an extended region comprising a second message prompt element and the second account identification element.

20. A non-transitory computer-readable storage medium, storing computer code which, when executed by at least one processor, causes the at least one processor to at least:
display a first scene picture corresponding to a virtual scene in a first observation range, the virtual scene comprising a plurality of virtual social objects that correspond to a plurality of social accounts, wherein the plurality of virtual social objects comprise a first social object corresponding to a first social account logged in with a terminal device;
display, based on receiving a first social message transmitted from a second social account, a first message prompt element and a first account identification element corresponding to the second social account, the first message prompt element being configured for triggering display of message content of the first social message;
display, based on a second social object corresponding to the second social account being in the virtual scene, a positioning mark element at a determined position corresponding to the first account identification element, wherein the positioning mark element indicates the second social object is in the virtual scene; and
switch, based on the positioning mark element, from the first observation range to a second observation range, to display a scene picture corresponding to the virtual scene in response to receiving a triggering operation performed on the first account identification element,
wherein the virtual scene comprises the second social object in the second observation range.
